(19) United States
(12) Patent Application Publication
(10) Pub. No.: US 2021/0095954 A1
(43) Pub. Date: Apr. 1, 2021

(54) GUIDED LASER INSPECTION AND ANALYSIS SYSTEM AND METHOD FOR A PROGRESSIVE CAVITY PUMP OR MOTOR ROTOR

(71) Applicant: MS Directional, LLC, Conroe, TX (US)

(72) Inventor: John C. GIBB, Houston, TX (US)

(73) Assignee: MS Directional, LLC, Conroe, TX (US)

(21) Appl. No.: 17/037,100

(22) Filed: Sep. 29, 2020

Related U.S. Application Data
(60) Provisional application No. 62/908,250, filed on Sep. 30, 2019.

(51) Int. Cl. G01B 11/24; F04C 2/107

(52) U.S. Cl. CPC G01B 11/24; F04C 2/1071

(57) ABSTRACT

The present disclosure provides a system and method for inspecting and analyzing a pump rotor, such as a progressive cavity pump rotor, by moving a laser that illuminates a surface of the pump rotor along a length of the pump rotor and determining distances from various surfaces of the pump rotor relative to a datum, such as a receiver of reflected radiation from the laser, along the length of the pump rotor. The pump rotor can be rotated relative to the laser, so that the laser can be used in determining multiple peripheral surfaces of the pump rotor to form a cross sectional shape, a longitudinal alignment of the pump rotor surfaces, or a combination thereof.

### CROSS REFERENCE TO RELATED APPLICATIONS

This application claims the benefit of U.S. Provisional Patent Application No. 62/908,250 entitled “Guided Laser Inspection and Analysis System and Method for a Progressive Cavity Pump or Motor Rotor”, filed on Sep. 30, 2020, which is incorporated herein by reference.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

### Field of the Invention

The disclosure generally relates to measurement systems and methods for complex profiles in pumps that can also function as a motor. More specifically, the disclosure relates to measurement systems and methods for complex profiles for a pump-motor rotor, such as a progressive cavity pump or motor rotor.

### Description of the Related Art

A progressive cavity pump is a mainstay in many fields. For example, in the oil and gas industry, chemical processing industry, cement pumping construction and mining slurry industries, and fuel delivery industries and other industries, a progressive cavity pump can be used to smoothly pump fluids and even dense slurries.

FIG. 1A is a schematic cross sectional side view of a typical progressive cavity pump 100 with an outer peripheral stator 106 and an inner rotor 108. The progressive cavity pump is also known as a progressive cavity positive displacement pump (PCPD). The progressive cavity pump, such as a Moineau-type device, differs from an auger conveyor. The progressive cavity pump rotor is typically formed with a single helix rotor and a double helix stator with a defined wavelength relative to the rotor. Typically, the rotor has one lobe less than the stator lobes. The rotor 108 uniquely rotates within the stator 106 to form an eccentric set of positive progressive cavities 110 along the length of the stator, similar to planet gears of a planetary gears system. The rotor seals tightly against the stator as it rotates, forming the set of cavities 110 in between. The cavities move when the rotor is rotated, but their shape or volume does not change. The pumped material is moved inside the cavities. The rotor 108 is typically formed of steel with a hard, abrasion resistive coating such as chromium. The stator 106 is typically formed of a metal tube body with a molded elastomer inside the tube body as a sealing surface for the rotating icy rotor.

FIG. 1B is a schematic cross sectional side view of a typical progressive cavity pump 100 in a motor configuration. In some industries, a progressive cavity pump can be alternatively used as a drive source such as a drilling motor, also known as a mud motor. (The term “progressive cavity pump” as used herein will also include its function as a motor, except where noted, and sometimes may be referred to herein as a progressive cavity pump/motor.) In such a configuration, the motor become a power section with the rotor 108 as a drive shaft in the stator 106. The rotor is typically attached to a universal or flex joint 116 and a tool 118, such as a downhole drilling bit. As fluids are pumped at pressure into an inlet 114 that flows into the progressive cavities 110 between the stator and rotor, the pressurized fluids cause the rotor 108 to rotate and power the tool 118. Such uses as a motor are particularly useful in directional well drilling in the oil and gas industry where the motor may be thousands of feet below the surface, but within fluid communication of the surface.

FIG. 2A is a cross sectional end view of rotor 108 inside a stator 106. FIG. 2B is a cross sectional end view of the rotor 108 of FIG. 2A. The rotor 108 has one or more lobes 120 formed between a major diameter 128 and a minor diameter 130. The stator 106 has a plurality of complementary lobes formed between a minor diameter 124 and a major diameter 126. The rotor lobes 120 rotate eccentrically around the stator lobes 122. The rotor major diameter 128 fits within the minor diameter 124 of the stator. Individual lobes of the rotor 108 can move reciprocally between the minor diameter 124 and the major diameter 126 of the stator 106, as the rotor rotates eccentrically around the inner surface of the stator.

An ideal fit between the stator and rotor is essential to maximize the elastomer life and achieve optimum pump or motor performance. For example, in the gravity-solids drilling environment of United States land drilling operations, significant wear is taking place on the power section rotors. Further, operating conditions can overpressure the pump used as a motor and damage the stator. When a maximum rated power output is exceeded by high pressure fluid, any additional hydraulic power that is furnished to it is dissipated by deformation of the stator. The stator deformation causes wear and reduces the rate at which a tool attached to the rotor can function.

If the fit is too loose, excessive slippage (leaking across the cavities in a pump) will result in decreased RPM and decreased pumping volume as a pump or decreased torque as a motor. A decrease in torque as a motor can disadvantageously reduce the rate that a drilling bit can penetrate a subsurface formation and increase the possibility of the motor stalling. Such a reduced performance as a motor is referred to as a weak motor that may ultimately lead to a downhole failure in an oil well that requires removal of a drill string of tubing and components, sometimes miles long, for a replacement motor. Unfortunately, such occurrences in the oil field are common and costly.

When newly manufacturing a stator or rotor, the machining is typically performed on computer numerically controlled machines, so that the stator and rotor can have the necessary dimensions to fit together for effective performance. One thousandth of an inch (25 micrometers) of variance can make a difference in the pump performance.

Because of the expense of a progressive cavity pump, components are refurbished or refitted into other assemblies. A slightly worn rotor might be matched with suitable stator. Too tight a fit causes friction, heat, and potential destruction of the elastomer in the stator. Too loose a fit caused by too much of a gap between the rotor and stator can cause the loss of pumping capacity and power for the torque referenced above. Further, the rotor can be substantively worn in some portion of the single helix along the rotor length and not in other portions.

FIG. 3A is a schematic side view of a method of measuring a progressive pump rotor diameter. FIG. 3B is a schematic end view of a method of measuring the progressive pump rotor diameter. FIG. 3C is a schematic end view of a method of measuring the progressive pump rotor longitudinal alignment. Due to the complexity of the shaped helix shown in FIG. 1 and precision needed, there is no satisfactory present method to measure this wear for determining the used rotor condition as the pump passes through the repair and maintenance cycle. The major diameter is not directly measured currently, but rather fixtures typically having plates and other surfaces bridge over the peripheral gaps to obtain a diametrical measurement. Further, longitudinal alignment of the rotor helical surfaces is difficult to measure due to the complexity and relies on fixtures to bridge the gaps between the helical surfaces that may miss localized nonconformities in the helical profile. Typically, the measurements are spot checked along a rotor length and may not sufficiently determine the worn portions in between the measurements.

FIG. 4A is a schematic cross sectional view of a worn rotor in a stator. FIG. 4B is a schematic enlarged portion of FIG. 4A. FIG. 4C is a schematic enlarged profile portion of the rotor in FIG. 4B showing a wear location. The rotor wear may not be on the major diameter 128 of the rotor 108, as described above. The wear may be on surfaces that a typical use of a micrometer would be unable to detect, especially for a helical profile of the rotor. The wear on a rotor 106 can be on a rotor surface 136, such as a rotor flank, between the major diameter 128 and the minor diameter 130. The wear at the rotor surface 136 provides leak paths and slippage, and therefore reduced pump or motor performance. Currently, such surfaces are not measured. Similar issues can occur on other types of pump rotors.

While some operators can measure an internal diameter of the stator with a laser, the complexities of the external surfaces of a rotor have not been so applied in a similar operation to used rotors.

Therefore, there remains a needs for an improved system and method of measuring complex shapes, including pump rotors, such as progressive cavity pump rotors.

### BRIEF SUMMARY OF THE INVENTION

The present disclosure provides a system and method for inspecting and analyzing a pump rotor, such as a progressive cavity pump rotor, by moving a laser that illuminates a surface of the pump rotor along a length of the pump rotor and determining distances from various surfaces of the pump rotor relative to a datum, such as a receiver of reflected radiation from the laser, along the length of the pump rotor. The pump rotor can be rotated relative to the laser, so that the laser can be used in determining multiple peripheral surfaces of the pump rotor to form a cross sectional shape, a longitudinal alignment of the pump rotor surfaces, or a combination thereof.

The present disclosure provides a guided laser inspection and analysis system for a pump rotor, comprising: a support frame having two supports with at least a first support having a drive motor configured to rotate a holder for a pump rotor about a longitudinal axis and a second support distal from the first support that is configured to maintain the pump rotor disposed between the supports and at least allow the pump rotor to rotate with the holder; a carrier configured to move longitudinally between the two supports and along a length of the pump rotor when disposed between the supports; a laser coupled to the carrier and configured to transmit a laser beam toward the pump rotor to illuminate a portion of the pump rotor when disposed between the supports; and a processor coupled to the laser and configured to electronically determine a distance between a datum and the portion of the pump rotor that is is illuminated by the laser beam.

The present disclosure provides a guided laser inspection and analysis system and method for a pump rotor, comprising: a support frame having at least one support with a holder configured to hold a pump rotor along a longitudinal axis and a drive motor configured to rotate the holder when the pump rotor is coupled with the holder; a carrier configured to move longitudinally toward and away from the support and along a length of the pump rotor when held by the holder; a laser coupled to the carrier and configured to transmit a laser beam toward the pump rotor to illuminate a portion of the pump rotor when held by the holder; and a processor coupled to the laser and configured to electronically determine a distance between a datum and the portion of the pump rotor that is illuminated by the laser beam.

The present disclosure further provides a method of inspecting and analyzing a pump rotor, comprising: mounting the pump rotor in a support frame having at least one support; rotating the rotor about a longitudinal axis; moving a laser along a longitudinal path aligned with the longitudinal axis; progressively illuminating portions of the rotor with a laser beam; and progressively determining distances electronically between a datum and the portions of the pump rotor that is illuminated by the laser beam.

### BRIEF DESCRIPTION OF THE SEVERAL VIEWS OF THE DRAWINGS

FIG. 1A is a schematic cross sectional side view of a typical progressive cavity pump with an outer peripheral stator and an inner rotor.

FIG. 1B is a schematic cross sectional side view of a typical progressive cavity pump 100 in a motor configuration.

FIG. 2A is a cross sectional end view of rotor inside a stator.

FIG. 2B is a cross sectional end view of the rotor of FIG. 2A.

FIG. 3A is a schematic side view of a method of measuring a progressive pump rotor diameter.

FIG. 3B is a schematic end view of a method of measuring the progressive pump rotor diameter.

FIG. 3C is a schematic end view of a method of measuring the progressive pump rotor longitudinal alignment.

FIG. 4A is a schematic cross sectional view of a worn rotor in a stator.

FIG. 4B is a schematic enlarged portion of FIG. 4A.

FIG. 4C is a schematic enlarged profile portion of the rotor in FIG. 4B showing a wear location.

FIG. 5 is a schematic side view of an illustrative system with a mounted pump rotor, according to the invention disclosed herein.

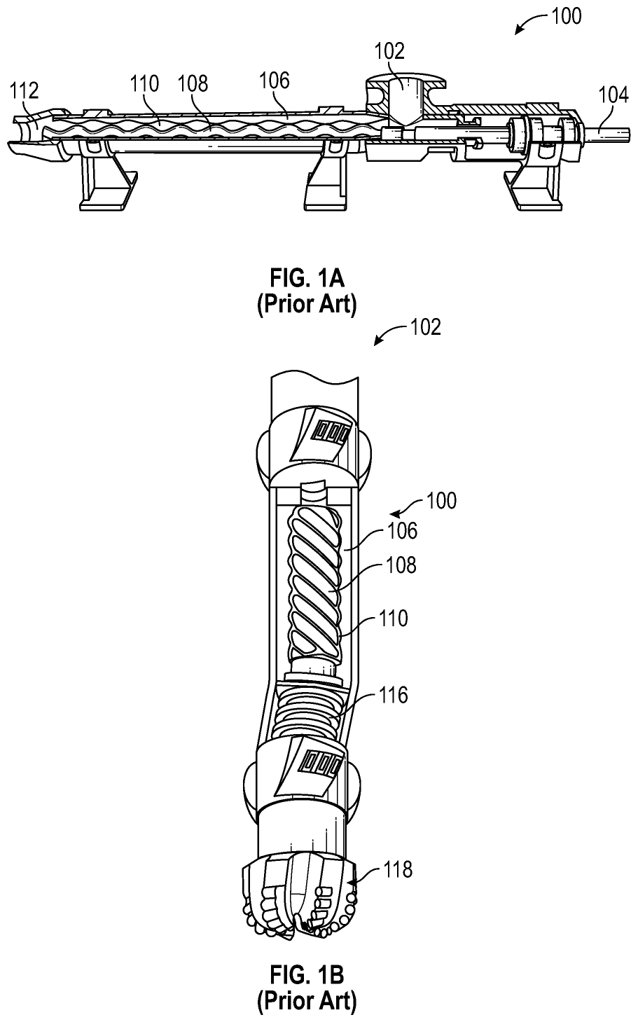

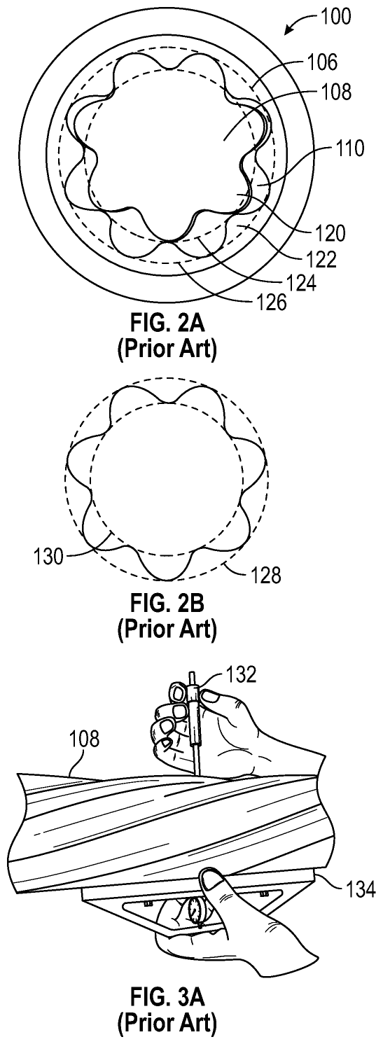

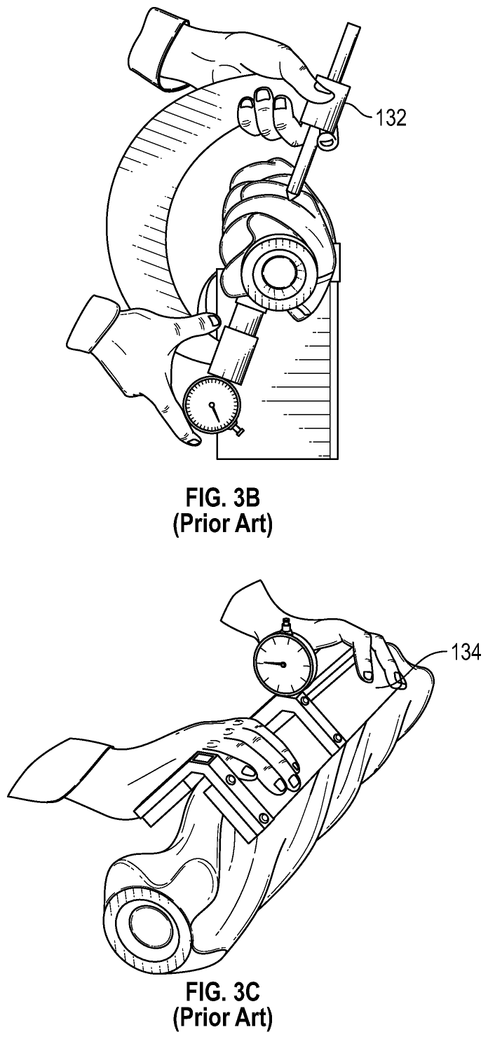

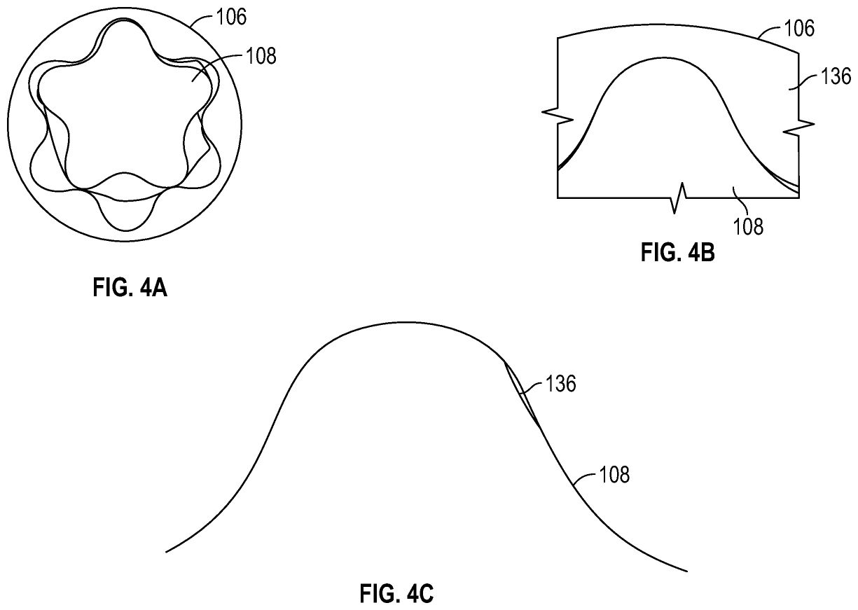

### DETAILED DESCRIPTION

The Figures described above and the written description of specific structures and functions below are not presented to limit the scope of what Applicant has invented or the scope of the appended claims, Rather, the Figures and written description are provided to teach any person skilled in the art how to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present disclosure will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation, location, or with time. While a developer's efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. The use of a singular term, such as, but not limited to, “a,” is not intended as limiting of the number of items. Further, the various methods and embodiments of the system can be included in combination with each other to produce variations of the disclosed methods and embodiments. Discussion of singular elements can include plural elements and vice-versa. References to at least one item may include one or more items. Also, is various aspects of the embodiments could be used in conjunction with each other to accomplish the understood goals of the disclosure. Unless the context requires otherwise, the term “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. The terms “top”, “up”, “upward”, “bottom”, “down”, “downwardly”, and like directional terms are used to indicate the direction relative to the figures and their illustrated orientation and are not absolute relative to a fixed datum such as the earth in commercial use. The term “inner,” “inward,” “internal” or like terms refers to a direction facing toward a center portion of an assembly or component, such as longitudinal centerline of the assembly or component, and the term “outer,” “outward,” “external” or like terms refers to a direction facing away from the center portion of an assembly or component. The term “coupled,” “coupling,” “coupler,” and like terms are used broadly herein and may include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and may further include without limitation integrally forming one functional member with another in a unitary fashion. The coupling may occur in any direction, including rotationally. The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions. Some elements are nominated by a device name for simplicity and would be understood to include a system of related components that are known to those with ordinary skill in the art and may not be specifically described. Various examples are provided in the description and figures that perform various functions and are non-limiting in shape, size, description, but serve as illustrative structures that can be varied as would be known to one with ordinary skill in the art given the teachings contained herein. As such, the use of the term “exemplary” is the adjective form of the noun “example” and likewise refers to an illustrative structure, and not necessarily a preferred embodiment. Element numbers with suffix letters, such as “A”, “B”, and so forth, are to designate different elements within a group of like elements having a similar structure or function, and corresponding element numbers without the letters are to generally refer to one or more of the like elements. Any is element numbers in the claims that correspond to elements disclosed in the application are illustrative and not exclusive, as several embodiments are disclosed that use various element numbers for like elements.

The present disclosure provides a system and method for inspecting and analyzing a pump rotor, such as a progressive cavity pump rotor, by moving a laser that illuminates a surface of the pump rotor along a length of the pump rotor and determining distances from various surfaces of the pump rotor relative to a datum, such as a receiver of reflected radiation from the laser, along the length of the pump rotor. The pump rotor can be rotated relative to the laser, so that the laser can be used in determining multiple peripheral surfaces of the pump rotor to form a cross sectional shape, a longitudinal alignment of the pump rotor surfaces, or a combination thereof.

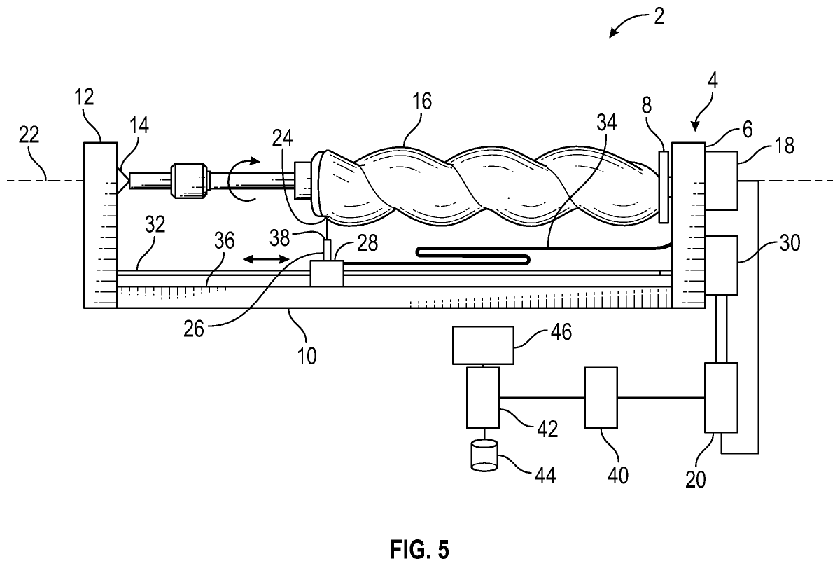

FIG. 5 is a schematic side view of an illustrative system with a mounted pump rotor, according to the invention disclosed herein. In at least one embodiment, an inspection and analysis system 2 can include a support frame having a first support 6 that can form a headstock, and a second support 12 that can form a tailstock. The first and second supports can be coupled through a base 10. The first support 6 can house a rotatable drive spindle coupled to a holder 8. The second support 12 can house a center 14 that can be rotatable and may not be powered. A pump rotor 16 can be mounted between the first support 6 and the second support 12 along a longitudinal axis 22. At least one of the supports can be coupled with a drive motor 18 to rotate the pump rotor, such as the first support 6 to rotate the spindle with the holder 8 for the zo pump rotor. In at least one embodiment, the drive motor 18 can be a stepper motor to control the relative angular orientation of the pump rotor about the longitudinal axis 22. In other embodiments, the drive motor can simply be a motor that rotates at a rotational speed.

A laser 26 can be used to illuminate portions of the surface of the pump rotor. The laser 26 when activated can be directed to a surface 24 of the pump rotor 16. The laser beam reflects off the surface and the reflected radiation is sensed by a receiver 38 at a fixed location relative to the laser to determine a distance between a receiver and the surface. The receiver location and distance to the surface 24 establishes a reference point for at least comparison of other distance measurements as the pump rotor rotates and/or the carrier with the laser moves longitudinally along the pump rotor. It may not be necessary in a given application to know an absolute distance as it may be sufficiently useful to know a comparison between the distance measurements. The distances can indicate nonconformities, such as sizes, out of round is dimensions, worn surfaces, alignments such as bends and twists, and other information.

The laser can be coupled to a carrier 28. The carrier 28 can move the laser longitudinally along a length of the pump rotor, such as along an aligned path with the longitudinal axis 22. The carrier can move along a carrier travel track 36 that can be coupled to the base 10 of the support frame 4 to help maintain a carrier alignment along the length of the pump rotor. An indexer 30 such as a stepper motor can be used to move the carrier with the laser. The indexer 30 can move a carrier actuator 32, such as a belt or chain, coupled to the carrier 28, so that the carrier moves back and forth between the first support and second support in the longitudinal direction. Power from the power supply 20 can be provided to the indexer 30. A laser conductor 34, such as a ribbon conductor, can be coupled to the laser and provide power from the power supply 20, such as through the indexer 30, to the laser on the carrier. The laser conductor 34 can also conduct data from the laser for further processing or to the laser for operational control.

In another embodiment, the indexer 30 and carrier actuator 32 can be in the form of a linear actuator that is coupled to the carrier 28 to move the carrier with the laser 26 back and forth in a longitudinal direction aligned with the longitudinal axis 22. Further, the laser 26 can be mounted to the linear actuator, so that the carrier 28 is essentially combined into the linear actuator.

A controller 40 can be used to control the power supply 20 for the drive motor 18 and the indexer 30, including the laser 26. The controller 40 can provide instructions to the power supply 20 and receive data from the laser 26, carrier 28, or a combination of both.

A processor 42 can receive data generated by use of the laser through the controller for determining the distance from a receiver 38 to the pump rotor surface indicated by the laser. The processor can store the data in a memory 44 in the form of a database or other format. The processor can provide electronic information to an output device 46. The output device 46 can provide the electronic information in print, visual or audible display or transmit electronic information that may be suitable for remote monitoring or reporting.

In operation, the pump rotor 16 can be mounted to the support frame 4, such as between the first support 6 and the second support 12. The indexer 30 and carrier actuator 32 can be actuated to start the laser 26 and carrier 28 at some suitable surface 24 on the pump rotor, such as an end of the pump rotor 16. The pump rotor can be rotated while the laser illuminates surfaces to produce measurements of the surface distances that are sent to the processor for processing the data. The result can be a defined contour of the pump rotor for the cross section at the particular longitudinal distance. The carrier and laser can be moved longitudinally and the process repeated at a different longitudinal position for the different cross section of the rotor. The carrier movement can be repeated until the process is completed. Alternatively, the process can be progressive so that as the pump rotor rotates, the carrier with the laser moves longitudinally until the process is completed. In such case a spiral of measurements could be determined with the density of the spiral depending on the rotational speed of the rotor and the longitudinally speed of the laser.

Alternatively, the laser 26 can be used to determine an initial distance of an initial surface 24 and the pump rotor 16 rotated about the longitudinal axis 22 to a different surface and another surface distance determined and so forth until the desired number or spacing of measurements are determined at a given longitudinal cross section of the rotor. The carrier 28 can move longitudinally to a different cross section of the pump rotor 16 and the process repeated. The carrier can be progressively moved in a longitudinal direction along the pump rotor until the measurements are complete.

As another alternative, the carrier with the laser can move longitudinally along the pump rotor without the pump rotor rotating to form a line of measurements at a fixed rotational orientation along the longitudinal axis. The pump rotor can be rotated to another rotational orientation and the process repeated and so forth until the measurements are completed.

The processor 42 with suitable software and database information can also determine a best match between the measured rotor and a suitable stator. From the memory 44 (which may be remote), data on stators and rotors, including a rotor then mounted in the support frame, and corresponding dimensions can be compared to determine which stator and rotor would form a best fit for pumping capacity, torque output, or a combination thereof. The output to the output device 46 can include recommendations for the matches. Using the high accuracy laser measurements can optimize the fit between the rotor and stator to ensure optimum performance of the pump, whether used in a pump configuration or a motor configuration.

Other and further embodiments utilizing one or more aspects of the inventions described above can be devised without departing from the disclosed invention as defined in the claims. For example, different support frames and shapes and sizes, a support frame with a single support that can suspend the pump rotor in a cantilever fashion along a longitudinal axis, a live drive on the second support, and other variations that are limited only by the scope of the claims.

The invention has been described in the context of preferred and other embodiments, and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, Applicant intends to protect fully all such modifications and improvements that come within the scope of the following claims.

What is claimed is:

1. A guided laser inspection and analysis system for a pump rotor, comprising:
a support frame having two supports with at least a first support having a drive motor configured to rotate a holder for a pump rotor about a longitudinal axis and a second support distal from the first support that is configured to maintain the pump rotor disposed between the supports and at least allow the pump rotor to rotate with the holder;
a carrier configured to move longitudinally between the two supports and along a length of the pump rotor when disposed between the supports;
a laser coupled to the carrier and configured to transmit a laser beam toward the pump rotor to illuminate a portion of the pump rotor when disposed between the supports; and
a processor coupled to the laser and configured to electronically determine a distance between a datum and the portion of the pump rotor that is illuminated by the laser beam.

2. The system of claim 1, wherein the processor is configured to determine distances between the datum and portions of the pump rotor as the holder rotates the pump rotor about a longitudinal axis and the laser illuminates such portions.

3. The system of claim 1, wherein the processor is configured to determine distances between the datum and portions of the pump rotor as the holder rotates the pump rotor and the carrier with the laser moves longitudinally between the two supports and illuminates such portions.

4. The system of claim 1, wherein the processor is configured to analyze the accumulated distances and determine cross sectional contours of the pump rotor, longitudinal alignments of surfaces of the pump rotor, or a combination thereof.

5. The system of claim 1, further comprising a base coupled between the supports, the base having a carrier travel track configured to guide the carrier longitudinally.

6. The system of claim 1, further comprising a carrier actuator coupled to the carrier and configured to move the carrier longitudinally.

7. The system of claim 6, wherein the carrier actuator comprises at least one of a belt drive, a screw drive, and a chain drive.

8. The system of claim 1, further comprising an indexer and configured to provide power to the carrier actuator to selectively move the carrier, provide power to the laser, or a combination thereof.

9. The system of claim 1, further comprising a controller coupled to the processor and power supply.

10. A guided laser inspection and analysis system and method for pump rotor, comprising:
a support frame having at least one support with a holder configured to hold a pump rotor along a longitudinal axis and a drive motor configured to rotate the holder when the pump rotor is coupled with the holder;
a carrier configured to move longitudinally toward and away from the support and along a length of the pump rotor when held by the holder;
a laser coupled to the carrier and configured to transmit a laser beam toward the pump rotor to illuminate a portion of the pump rotor when held by the holder; and
a processor coupled to the laser and configured to electronically determine a distance between a datum and the portion of the pump rotor that is illuminated by the laser beam.

11. The system of claim 10, wherein the processor is configured to determine distances between the datum and portions of the pump rotor as the holder rotates the pump rotor about a longitudinal axis and the laser illuminates such portions.

12. The system of claim 10, wherein the processor is configured to determine distances between the datum and portions of the pump rotor as the holder rotates the pump rotor and the carrier with the laser moves longitudinally between the two supports and illuminates such portions.

13. A method of inspecting and analyzing a pump rotor, comprising:
mounting the pump rotor in a support frame having at least one support;
rotating the rotor about a longitudinal axis;
moving a laser along a longitudinal path aligned with the longitudinal axis;
progressively illuminating portions of the rotor with a laser beam; and
progressively determining distances between a datum and the portions of the pump rotor that are illuminated by the laser beam.

14. The method of claim 13, wherein progressively determining distances further comprises processing the distances to determine sizes of the rotor at selected cross sections, longitudinal alignment of the rotor, or a combination thereof.

15. The method of claim 13, further comprising matching a stator and a rotor based on the distances between the datum and the portions of the pump rotor that are illuminated by the laser beam.
